(19) United States
(12) Patent Application Publication
(10) Pub. No.: US 2025/0369585 A1
(43) Pub. Date: Dec. 4, 2025

(54) LIQUID CRYSTAL ELEMENT, LIGHTING APPARATUS, VEHICLE LAMP SYSTEM

(71) Applicant: STANLEY ELECTRIC CO., LTD., Meguro-ku, Tokyo (JP)

(72) Inventors: Yasuo TOKO, Tokyo (JP); Megumi OTA, Tokyo (JP)

(73) Assignee: STANLEY ELECTRIC CO., LTD., Meguro-ku, Tokyo (JP)

(21) Appl. No.: 18/877,845

(22) PCT Filed: May 16, 2023
(86) PCT No.: PCT/JP2023/018298

§ 371 Date: Dec. 20, 2024

(30) Foreign Application Priority Data
Jun. 22, 2022 (JP) 2022-100502

(51) Int. Cl. F21S 41/64; G02F 1/1368

(52) U.S. Cl. CPC F21S 41/645; G02F 1/1368

(57) ABSTRACT

A liquid crystal element includes: a first substrate, a second substrate, and a liquid crystal layer; pixel electrodes on the first substrate side by using a transparent conductive film, including those having different shapes; thin film switching elements disposed on the first substrate side, and that correspond respectively to the pixel electrodes; first wirings on the first substrate side by using a transparent conductive film, and interconnect the pixel electrodes and thin film switching elements; and a counter electrode on the second substrate side and disposed to overlap the pixel electrodes; where the pixel electrodes are disposed within a first region where image formation light is irradiated, and where the thin film switching elements is disposed in a second region adjacent to the first region that is not irradiated with the image formation light.

### TECHNICAL FIELD

The present disclosure relates to a liquid crystal element, a lighting apparatus, and a vehicle lamp system.

### BACKGROUND ART

Japanese Unexamined Patent Application Publication No. 2006-58730 (Patent Document 1) describes an active matrix driven liquid crystal display apparatus in which pixels including organic TFTs are disposed at each intersection of orthogonal gate lines and data lines, and in which the source electrodes, drain electrodes, and auxiliary capacitance electrodes are made of transparent conductive materials.

However, while this liquid crystal display apparatus improves the aperture ratio to some extent by making the auxiliary capacitance electrode transparent, since parts such as the source electrode and drain electrode do not contribute to image display even if they are made transparent, these parts may always be in a dark state. These parts that cause such a dark state are undesirable, especially in an application where strong light is used to form images, as they cause noticeable dark lines and dark spots. Further, since each organic TFT is disposed adjacent to each pixel electrode and these organic TFTs are also exposed to light, there is a possibility that light resistance will decrease, especially in an application where strong light is used to form images.

### PRIOR ART DOCUMENT

### Patent Document

[Patent Document 1] Japanese Unexamined Patent Application Publication No. 2006-58730

### SUMMARY OF THE INVENTION

### Technical Problem

In a specific aspect, it is an object of the present disclosure to provide a technology that can prevent occurrence of dark lines and decrease in light resistance in a liquid crystal element used for image formation using strong light.

### Solution to the Problem

(1) A liquid crystal element according to one aspect of the present disclosure is a liquid crystal element including: (a) a first substrate and a second substrate disposed with one surface facing each other; (b) a liquid crystal layer disposed between the first substrate and the second substrate; (c) a plurality of pixel electrodes including those having different shapes in a plane view, which are provided on the first substrate side using a transparent conductive film; (d) a plurality of thin film switching elements provided on the first substrate side, each corresponding to each of the pixel electrodes; (e) a plurality of first wirings provided on the first substrate side using a transparent conductive film, which connects each of the pixel electrodes and each of the thin film switching elements; and (f) a counter electrode provided on the second substrate side, which is disposed to overlap each of the pixel electrodes in a plane view; (g) where each of the pixel electrodes is entirely disposed within a first region to which light for image formation is irradiated, and (h) where each of the thin film switching elements is disposed in a second region that is adjacent to the first region in a plane view and to which the light for image formation is not irradiated.

(2) A liquid crystal element according to one aspect of the present disclosure is a liquid crystal element including: (a) a first substrate and a second substrate disposed with one surface facing each other; (b) a liquid crystal layer disposed between the first substrate and the second substrate; (c) a plurality of pixel electrodes including those having different shapes in a plane view, which are provided on the first substrate side using a transparent conductive film; (d) a plurality of thin film switching elements provided on the first substrate side, each corresponding to each of the pixel electrodes; (e) a plurality of first wirings provided on the first substrate side using a transparent conductive film, which connects each of the pixel electrodes and each of the thin film switching elements; and (f) a counter electrode provided on the second substrate side, which is disposed to overlap each of the pixel electrodes in a plane view; (g) where each of the thin film switching elements has a plurality of first thin film switching elements and a plurality of second thin film switching elements, and at least each of the first thin film switching elements is made of an organic semiconductor; (h) where each of the pixel electrodes and each of the first switching elements are entirely disposed in a first region to which light for image formation is irradiated; and (i) where each of the second thin film switching elements is disposed in a second region adjacent to the first region in a plane view and to which the light for image formation is not irradiated.

(3) A lighting apparatus according to one aspect of the present disclosure is a lighting apparatus including: (a) the liquid crystal element according to the above-described (1) or (2); (b) a light source; (c) a light condensing part that collects light emitted from the light source to form the light for image formation and causes the light for image formation to be incident on the liquid crystal element; (d) a pair of polarizing elements that are disposed opposite each other with the liquid crystal element therebetween; and (e) a lens that projects the light that has passed through the liquid crystal element.

(4) A vehicle lamp system according to one aspect of the present disclosure is a vehicle lamp system including: (a) a vehicle lamp configured using the lighting apparatus according to the above-described (3); (b) a sensor that detects a target object present around a vehicle; and (c) a controller that controls operation of the liquid crystal element in accordance with the state of the target object detected by the sensor.

According to the above configurations, it is possible to prevent occurrence of dark lines and decrease in light resistance in a liquid crystal element used for image formation using strong light, or in a lighting apparatus that uses such liquid crystal element.

### BRIEF DESCRIPTION OF THE DRAWINGS

FIG. 1(A) to FIG. 1(C) are partial cross-sectional views showing the configuration of a liquid crystal element according to a first embodiment.

FIG. 2 is a plane view showing the configuration of electrodes and wiring of the liquid crystal element of the first embodiment.

FIG. 3 is a plane view showing the configuration of wiring of the liquid crystal element of the first embodiment.

FIG. 4 is a plane view for explaining the region where light is irradiated on the liquid crystal element and the position where the sealing material is provided.

FIG. 5 is a plane view showing the configuration of electrodes and wiring of a liquid crystal element according to a second embodiment.

FIG. 6(A) to FIG. 6(F) are diagrams for explaining a manufacturing method for forming a mixture of a thin film transistor using an inorganic semiconductor and a thin film transistor using an organic semiconductor.

FIG. 7 is a plane view showing the configuration of electrodes and wiring of a liquid crystal element according to a third embodiment.

FIG. 8(A) and FIG. 8(B) are partial cross-sectional views showing the configuration of the first substrate of the liquid crystal element of the third embodiment.

FIG. 9(A) and FIG. 9(B) are diagrams showing the configuration of a vehicle lamp system according to one embodiment which is configured using the liquid crystal element according to the above-described embodiments.

### MODE FOR CARRYING OUT THE INVENTION

### First Embodiment

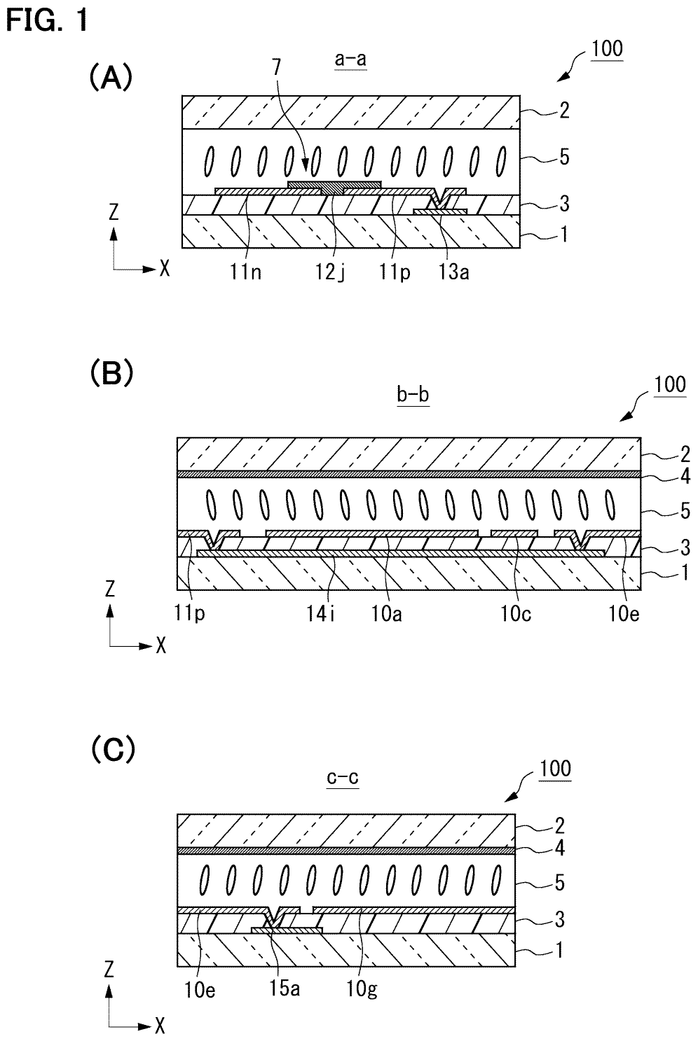

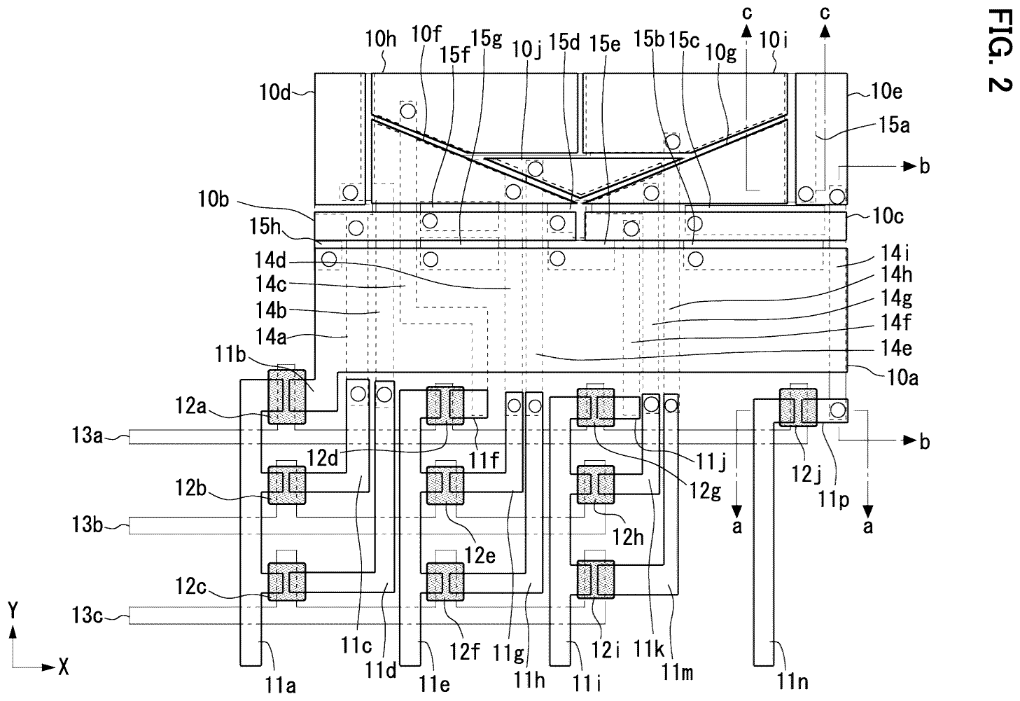

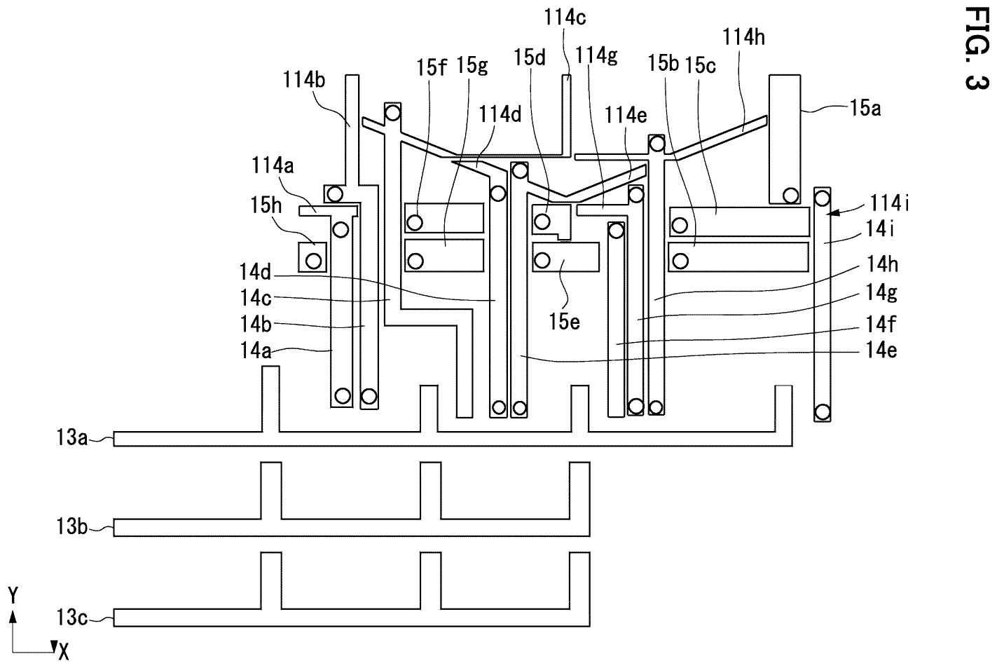

FIG. 1(A) to FIG. 1(C) are partial cross-sectional views showing the configuration of a liquid crystal element according to a first embodiment. FIG. 2 is a plane view showing the configuration of electrodes and wiring of the liquid crystal element of the first embodiment. FIG. 3 is a plane view showing the configuration of wiring of the liquid crystal element of the first embodiment. Here, note that FIG. 1(A) corresponds to the cross section taken along line a-a in FIG. 2, FIG. 1(B) corresponds to the cross section taken along line b-b in FIG. 2, and FIG. 1(C) corresponds to the cross section taken along line c-c in FIG. 2.

The liquid crystal element 100 of the first embodiment shown in FIG. 1(A) to FIG. 1(C) includes, as its main components, a first substrate 1 and a second substrate 2 disposed opposite each other with a liquid crystal layer 5 therebetween, an insulating layer (insulating film) 3 provided on one surface of the first substrate 1 facing the liquid crystal layer 5, a counter electrode 4 provided on one surface of the second substrate 2 facing the liquid crystal layer 5 side, and a liquid crystal layer 5 disposed between each surface of the first substrate 1 and the second substrate 2.

The first substrate 1 and the second substrate 2 are each a rectangular light-transmitting substrate in a plane view, for example, and are disposed opposite each other. Spherical spacers (not shown) made of a resin film are dispersed between the first substrate 1 and the second substrate 2, for example, and these spherical spacers maintain a gap between the substrates at a desired size (for example, about a few μm). Here, instead of spherical spacers, columnar bodies made of resin or the like may be provided on the first substrate 1 side or the second substrate 2 side and used as spacers.

The insulating layer 3 is disposed on one surface side of the first substrate 1, covering a plurality of lower wirings 13a-13c, a plurality of lower wirings 14a-14i, and a plurality of inter-pixel electrodes 15a-15h provided on that surface. This insulating film 3 is a film for achieving electrical insulation between the lower wirings 13a, etc. and the pixel electrodes 10a-10j and wirings 11a-11p. The insulating film 3 can be a siloxane-based insulating film, an acrylic-based organic insulating film, or an inorganic insulating film such as a SiNx film or a SiOx film, for example.

The counter electrode 4 is provided on one surface side of the second substrate 2 in an area that overlaps at least each of the pixel electrodes 10a in a plane view. Here, the counter electrode 4 may be divided into multiple parts. The counter electrode 4 is formed by appropriately patterning a transparent conductive film such as indium tin oxide (ITO). In the present embodiment, a pixel part is formed in each of the portions where each of the pixel electrodes 10a etc. faces the counter electrode 4.

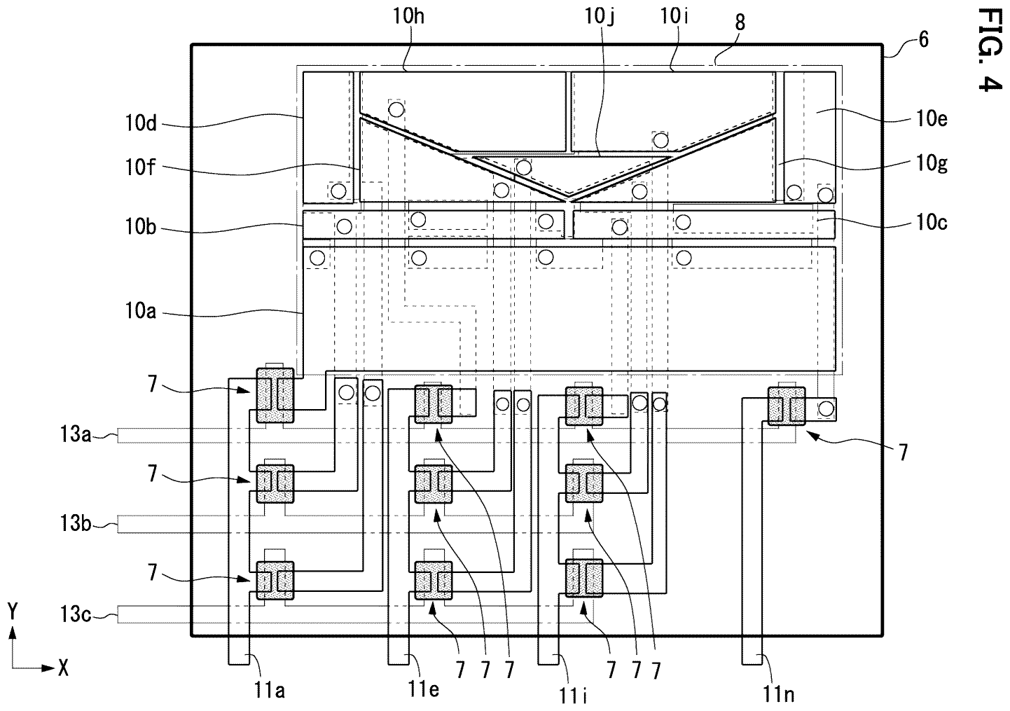

The liquid crystal layer 5 is provided between the first substrate 1 and the second substrate 2. The liquid crystal layer 5 is made of a nematic liquid crystal material having fluidity, for example. The liquid crystal layer 5 is made of a liquid crystal material having negative dielectric anisotropy, for example. The thickness of the liquid crystal layer 5 can be set to about 4 μm, for example. The liquid crystal layer 5 is surrounded by a sealing material 6 (refer to FIG. 4) and is protected from the outside. Here, although not shown, the first substrate 1 and the second substrate 2 are appropriately provided with alignment films, and these alignment films determine the initial alignment state of the liquid crystal layer 5.

Here, in the first embodiment, the layer including the plurality of lower wirings 13a-13c, the plurality of lower wirings 14a-14i, and the plurality of inter-pixel electrodes 15a-15h and provided relatively closer to one surface of the first substrate 1 corresponds to a “first layer”, and the layer including the pixel electrodes 10a-10j and wirings 11a-11p and provided relatively farther from one surface of the first substrate 1 corresponds to a “second layer”. The insulating layer 3 described above is provided between these first and second layers. Further, each of the plurality of lower wirings 14a-14i corresponds to a “first wiring”, each of the plurality of lower wirings 13a-13c corresponds to a “second wiring”, and each of the plurality of wirings 11a-11p corresponds to a “third wiring”.

The pixel electrodes 10a to 10j are provided on one surface of the insulating layer 3 (the surface close to the liquid crystal layer 5) on one surface side of the first substrate 1. Each of the pixel electrodes 10a, etc. is formed by appropriately patterning a transparent conductive film such as indium tin oxide (ITO). As shown in FIG. 2, each of the pixel electrodes 10a to 10j includes an electrode having a different shape in a plane view, and they are arranged physically separated from each other.

Pixel electrode 10a has a rectangular shape with its elongated shape in the X direction (left-right direction) in the figure, in a plane view. Each of the pixel electrodes 10b, 10c has a rectangular shape with its elongated shape in the X direction in a plane view, and is disposed adjacent to each other in the X direction. The length in the Y direction of each of the pixel electrodes 10b, 10c is approximately the same as the length in the Y direction of pixel electrode 10a, and they are approximately the same shape in a plane view.

The length of each of the pixel electrodes 10d, 10e in the X direction is approximately half of that of pixel electrode 10a, and they have roughly the same shape in a plane view. Each of the pixel electrodes 10d, 10e has a rectangular shape with its elongated shape in the Y direction in a plane view, and is disposed above pixel electrodes 10b, 10c in the figure, with the other pixel electrodes 10f, 10g, 10h, 10i, and 10j sandwiched therebetween.

Each of the pixel electrodes 10f, 10g has a right-angled triangular shape that is longer in the X direction in a plane view, and is disposed above each of the pixel electrodes 10b, 10c in the figure. Each of the pixel electrodes 10f, 10g has the same length in the X direction and the same length in the Y direction, is roughly the same shape in a plane view, and is laterally symmetrical in the figure.

Each of the pixel electrodes 10h, 10i has a pentagonal shape that is longer in the X direction in a plane view, and is disposed above each of the pixel electrodes 10f, 10g in the figure. Each of the pixel electrodes 10h, 10i has the same length in the X direction and the same length in the Y direction, is roughly the same shape in a plane view, and is laterally symmetrical in the figure.

The pixel electrode 10j has a downward-facing isosceles triangle shape in a plane view, and is surrounded by the pixel electrodes 10f, 10g, 10h, and 10i.

Wirings 11a to 11p are provided on one surface of the insulating layer 3 (the surface close to the liquid crystal layer 5) on one surface side of the first substrate 1. Each of the wirings 11a, etc. is formed by appropriately patterning a transparent conductive film such as indium tin oxide (ITO). Each of the wirings 11a, etc. is provided on the same layer as each of the pixel electrodes 10a, etc.

Wiring 11a has a plane view shape extending in the Y direction and has portions overlapping with each of semiconductor layers 12a, 12b, and 12c. Similarly, wiring 11e has a plane view shape extending in the Y direction and has portions overlapping with each of semiconductor layers 12d, 12e, and 12f. Similarly, wiring 11i has a plane view shape extending in the Y direction and has portions overlapping with each of semiconductor layers 12g, 12h, and 12i. Similarly, wiring 11n has a plane view shape extending in the Y direction and has a portion overlapping with a semiconductor layer 12j. These portions function as source/drain electrodes (input/output electrodes) of a thin film transistor. Hereinafter, these portions may be simply referred to as “source/drain electrodes”.

Wiring 11b is connected to the pixel electrode 10a and has a portion that overlaps with the semiconductor layer 12a. This portion functions as the source/drain electrode of the thin film transistor.

The semiconductor layer 12a is provided so as to overlap with the source/drain electrodes of each of wiring 11a and wiring 11b. By including these source/drain electrodes and the semiconductor layer 12a, a gate electrode which is a portion of the lower wiring 13a (which will be described later) that overlaps with the semiconductor layer 12a, and an insulating layer 3 interposed between wirings 11a, 11b and the lower wiring 13a, one thin film transistor 7 is formed. The cross-sectional structure of this thin film transistor 7 is the same as that shown in FIG. 1(A) (same applies to the other thin film transistors 7 described hereinafter).

The semiconductor layer 12a is formed with a channel width (the width of the area forming the channel region, the length in the Y direction in the figure) that is relatively larger than the other semiconductor layers 12b, etc. This is because the area of the pixel electrode 10a connected to the thin film transistor 7 which is configured to include the semiconductor layer 12a is larger than the other pixel electrodes 10b, etc., and therefore a higher driving capability needs to be ensured.

The semiconductor layer 12a and the other semiconductor layers 12b to 12j are preferably configured using organic semiconductors, for example. Organic semiconductors can be patterned using simple methods such as printing method, and do not require photolithography steps using expensive masks or vacuum processes, thereby can reduce manufacturing costs.

Wiring 11c is connected to the pixel electrode 10b via the lower wiring 14a (which will be described later) and has a portion (source/drain electrode) that overlaps with a semiconductor layer 12b. The semiconductor layer 12b is provided so as to overlap with the source/drain electrodes of each of wiring 11a and wiring 11c. By including these source/drain electrodes and the semiconductor layer 12b, a gate electrode which is a portion of the lower wiring 13b (which will be described later) that overlaps with the semiconductor layer 12b, and an insulating layer 3 interposed between each of wirings 11a, 11c and the lower wiring 13b, one thin film transistor 7 is formed.

Wiring 11d is connected to the pixel electrode 10d via the lower wiring 14b (which will be described later) and has a portion (source/drain electrode) that overlaps with a semiconductor layer 12c. The semiconductor layer 12c is provided so as to overlap with the source/drain electrodes of each of wiring 11a and wiring 11d. By including these source/drain electrodes and the semiconductor layer 12c, a gate electrode which is a portion of the lower wiring 13c (which will be described later) that overlaps with the semiconductor layer 12c, and an insulating layer 3 interposed between each of wirings 11a, 11d and the lower wiring 13c, one thin film transistor 7 is formed.

Wiring 11f is connected to pixel electrode 10h via the lower wiring 14c (which will be described later) and has a portion (source/drain electrode) that overlaps with a semiconductor layer 12d. The semiconductor layer 12d is provided so as to overlap with the source/drain electrodes of each of wiring 11e and wiring 11f. By including these source/drain electrodes and the semiconductor layer 12d, a gate electrode which is a portion of the lower wiring 13a that overlaps with the semiconductor layer 12d, and an insulating layer 3 interposed between each of wirings 11e, 11f and the lower wiring 13a, one thin film transistor 7 is formed.

Wiring 11g is connected to the pixel electrode 10f via the lower wiring 14d (which will be described later) and has a portion (source/drain electrode) that overlaps with a semiconductor layer 12e. The semiconductor layer 12e is provided so as to overlap with the source/drain electrodes of each of wiring 11e and wiring 11g. By including these source/drain electrodes and the semiconductor layer 12e, a gate electrode which is a portion of the lower wiring 13b that overlaps with the semiconductor layer 12e, and an insulating layer 3 interposed between each of wirings 11e, 11g and the lower wiring 13b, one thin film transistor 7 is formed.

Wiring 11h is connected to the pixel electrode 10j via the lower wiring 14e (which will be described later) and has a portion (source/drain electrode) that overlaps with a semiconductor layer 12f. The semiconductor layer 12f is provided so as to overlap with the source/drain electrodes of each of wiring 11e and wiring 11h. By including these source/drain electrodes and the semiconductor layer 12f, a gate electrode which is a portion of the lower wiring 13c that overlaps with the semiconductor layer 12f, and an insulating layer 3 interposed between each of wirings 11e, 11h and the lower wiring 13c, one thin film transistor 7 is formed.

Wiring 11j is connected to pixel electrode 10c via the lower wiring 14f (which will be described later) and has a portion (source/drain electrode) that overlaps with a semiconductor layer 12g. The semiconductor layer 12g is provided so as to overlap with the source/drain electrodes of each of wiring 11i and wiring 11j. By including these source/drain electrodes and the semiconductor layer 12g, a gate electrode which is a portion of the lower wiring 13a that overlaps with the semiconductor layer 12g, and an insulating layer 3 interposed between each of wirings 11i, 11j and the lower wiring 13a, one thin film transistor 7 is formed.

Wiring 11k is connected to pixel electrode 10g via the lower wiring 14g (which will be described later) and has a portion (source/drain electrode) that overlaps with a semiconductor layer 12h. The semiconductor layer 12h is provided so as to overlap with the source/drain electrodes of each of wiring 11i and wiring 11k. By including these source/drain electrodes and the semiconductor layer 12h, a gate electrode which is a portion of the lower wiring 13b that overlaps with the semiconductor layer 12h, and an insulating layer 3 interposed between each of wirings 11i, 11k and the lower wiring 13b, one thin film transistor 7 is formed.

Wiring 11m is connected to pixel electrode 10i via the lower wiring 14h (which will be described later) and has a portion (source/drain electrode) that overlaps with a semiconductor layer 12i. The semiconductor layer 12i is provided so as to overlap with the source/drain electrodes of each of wiring 11i and wiring 11m. By including these source/drain electrodes and the semiconductor layer 12i, a gate electrode which is a portion of the lower wiring 13c that overlaps with the semiconductor layer 12i, and an insulating layer 3 interposed between each of wirings 11i, 11m and the lower wiring 13c, one thin film transistor 7 is formed.

Wiring 11p is connected to the pixel electrode 10e via the lower wiring 14i (which will be described later) and has a portion (source/drain electrode) that overlaps with a semiconductor layer 12j. The semiconductor layer 12j is provided so as to overlap with the source/drain electrodes of each of wiring 11n and wiring 11p. By including these source/drain electrodes and the semiconductor layer 12j, a gate electrode which is a portion of the lower wiring 13a that overlaps with the semiconductor layer 12j, and an insulating layer 3 interposed between each of wirings 11n, 11p and the lower wiring 13a, one thin film transistor 7 is formed.

The lower wiring 13a has a plane view shape extending in the X direction, and has four portions each extending in the Y direction. These four portions are disposed so as to overlap semiconductor layers 12a, 12d, 12g, and 12j, respectively, in a plane view, and function as gate electrodes (control electrodes) in each of the thin film transistors 7 configured to include each of the semiconductor layers 12a, etc.

The lower wiring 13b has a plane view shape extending in the X direction, and has three portions each extending in the Y direction. These three portions are disposed so as to overlap semiconductor layers 12b, 12e, and 12h, respectively, in a plane view, and function as gate electrodes in each of the thin film transistor 7 configured to include each of the semiconductor layers 12b, etc.

The lower wiring 13c has a plane view shape extending in the X direction, and has three portions each extending in the Y direction. These three portions are disposed so as to overlap semiconductor layers 12c, 12f, and 12i, respectively, in a plane view, and function as gate electrodes in each of the thin film transistor 7 configured to include each of the semiconductor layers 12c, etc.

The lower wiring 14a has a plane view shape extending in the Y direction in the figure, and electrically connects wiring 11c and the pixel electrode 10b. The lower wiring 14a is physically and electrically connected to wiring 11c and the pixel electrode 10b through each contact hole (schematically shown by a circle in the figure; the same applies hereinafter) provided in the insulating layer 3. Further, the lower wiring 14a of the present embodiment has a portion 114a that is disposed to overlap the gap between the pixel electrode 10b and the pixel electrode 10d and functions as an inter-pixel electrode. The “inter-pixel electrode” here is an electrode that has the same potential as the pixel electrode 10b, which enables voltage application to the liquid crystal layer 5, and essentially functions to expand the pixel part (the same applies hereinafter).

The lower wiring 14b has a plane view shape extending in the Y direction in the figure, and electrically connects wiring 11d and the pixel electrode 10d. The lower wiring 14b is physically and electrically connected to wiring 11d and the pixel electrode 10d via each contact hole provided in the insulating layer 3. Further, the lower wiring 14b in this embodiment has a portion 114b that is disposed to overlap the gap between the pixel electrode 10d and the pixel electrode 10h and functions as an inter-pixel electrode.

The lower wiring 14c has a plane view shape extending in the Y direction in the figure, and electrically connects wiring 11f and the pixel electrode 10h. The lower wiring 14c is physically and electrically connected to each of wiring 11f and the pixel electrode 10h via each contact hole provided in the insulating layer 3. Further, the lower wiring 14c in the present embodiment has a portion 114c that is disposed to overlap the gap between the pixel electrode 10h and the pixel electrodes 10f, 10i, and 10j and functions as an inter-pixel electrode.

The lower wiring 14d has a plane view shape extending in the Y direction in the figure, and electrically connects wiring 11g and the pixel electrode 10f. The lower wiring 14d is physically and electrically connected to wiring 11g and the pixel electrode 10f via each contact hole provided in the insulating layer 3. Further, the lower wiring 14d in the present embodiment has a portion 114d that is disposed to overlap the gap between the pixel electrodes 10f and the pixel electrodes 10j and functions as an inter-pixel electrode.

The lower wiring 14e has a plane view shape extending in the Y direction in the figure, and electrically connects wiring 11h and the pixel electrode 10j. The lower wiring 14e is physically and electrically connected to each of wiring 11h and the pixel electrode 10j via each contact hole provided in the insulating layer 3. Further, the lower wiring 14e of the present embodiment has a portion 114e that is disposed to overlap the gap between the pixel electrode 10j and the pixel electrodes 10f and 10g and functions as an inter-pixel electrode.

The lower wiring 14f has a plane view shape extending in the Y direction in the figure, and electrically connects wiring 11j and the pixel electrode 10c. The lower wiring 14f is physically and electrically connected to each of wiring 11j and the pixel electrode 10c via each contact hole provided in the insulating layer 3.

The lower wiring 14g has a plane view shape extending in the Y direction in the figure, and electrically connects wiring 11k and the pixel electrode 10g. The lower wiring 14g is physically and electrically connected to wiring 11k and the pixel electrode 10g via each contact hole provided in the insulating layer 3. Further, the lower wiring 14g of the present embodiment has a portion 114g that is disposed to overlap the gap between the pixel electrode 10g and the pixel electrode 10c and functions as an inter-pixel electrode.

The lower wiring 14h has a plane view shape extending in the Y direction in the figure, and electrically connects wiring 11m and the pixel electrode 10i. The lower wiring 14g is physically and electrically connected to wiring 11m and the pixel electrode 10i via each contact hole provided in the insulating layer 3. Further, the lower wiring 14h of the present embodiment has a portion 114h that is disposed to overlap the gap between the pixel electrode 10i and the pixel electrodes 10g and 10j and functions as an inter-pixel electrode.

The lower wiring 14i has a plane view shape extending in the Y direction in the figure, and electrically connects wiring 11p and the pixel electrode 10e. The lower wiring 14g is physically and electrically connected to each of wiring 11p and the pixel electrode 10e via each contact hole provided in the insulating layer 3. Further, the lower wiring 14i of the present embodiment has a portion 114i that is disposed to overlap the gap between the pixel electrode 10c and the pixel electrode 10e and functions as an inter-pixel electrode.

The inter-pixel electrode 15a is physically and electrically connected to the pixel electrode 10e via a contact hole in the insulating layer 3, and is provided so as to overlap the gap between the pixel electrode 10e and the pixel electrodes 10g and 10i. This inter-pixel electrode 15 has the same potential as the pixel electrode 10e when a voltage is applied to the pixel electrode 10e, thereby has the function of substantially expanding the pixel part (the same applies to the other inter-pixel electrodes described hereinafter).

The inter-pixel electrode 15b is physically and electrically connected to the pixel electrode 10a via a contact hole in the insulating layer 3, and is provided so as to overlap the gap between the pixel electrode 10a and the pixel electrode 10c.

The inter-pixel electrode 15c is physically and electrically connected to the pixel electrode 10c via a contact hole in the insulating layer 3, and is provided so as to overlap the gap between the pixel electrode 10c and the pixel electrodes 10e and 10g.

The inter-pixel electrode 15d is physically and electrically connected to the pixel electrode 10b via a contact hole in the insulating layer 3, and is provided so as to overlap the gap between the pixel electrode 10b and the pixel electrodes 10f and 10j.

The inter-pixel electrode 15e is physically and electrically connected to the pixel electrode 10a via a contact hole in the insulating layer 3, and is provided so as to overlap the gap between the pixel electrode 10a and the pixel electrodes 10b and 10c.

The inter-pixel electrode 15f is physically and electrically connected to the pixel electrode 10b via a contact hole in the insulating layer 3, and is provided so as to overlap the gap between the pixel electrode 10b and the pixel electrode 10f.

The inter-pixel electrode 15g is physically and electrically connected to the pixel electrode 10a via a contact hole in the insulating layer 3, and is provided so as to overlap the gap between the pixel electrode 10a and the pixel electrode 10b.

The inter-pixel electrode 15h is physically and electrically connected to the pixel electrode 10a via a contact hole in the insulating layer 3, and is provided so as to overlap the gap between the pixel electrode 10a and the pixel electrode 10b.

The above-described lower wirings 14f, 14g, and 14h are disposed between the inter-pixel electrodes 15b and 15c and the inter-pixel electrodes 15d and 15e. The above-described lower wirings 14d and 14e are disposed between the inter-pixel electrodes 15d and 15e and the inter-pixel electrodes 15f and 15g. The above-described lower wirings 14a, 14b, and 14c are disposed between the inter-pixel electrodes 15f and 15g and the inter-pixel electrode 15h.

In the liquid crystal element 100 of the first embodiment, a voltage (a scanning signal) is applied to each thin film transistor 7 via each of the lower wirings 13a-13c, and a voltage (a data signal) is applied via each of wirings 11a, 11e, 11i, 11n, so that a drive voltage can be individually supplied to each of the pixel electrode 10a, etc. Therefore, light transmission state in the pixel parts defined by each of the pixel electrodes 10a, etc. can be individually controlled to form an image using the transmitted light.

In the liquid crystal element 100 of the first embodiment, by using lower wirings 13a, etc., it is not necessary to provide wiring between each of the pixel electrodes 10a, etc., so the gap between each of the pixel electrodes 10a in a plane view can be made narrower. As a result, this improves light utilization efficiency and suppresses the problem of dark grids, in which the spaces between the pixels become dark. This is particularly beneficial in a situation where strong light is incident on the liquid crystal element 100, such as when the liquid crystal element 100 is incorporated into a vehicle lamp. Further, by providing inter-pixel electrodes, the problem of dark grids is further suppressed and light utilization efficiency is improved.

FIG. 4 is a plane view for explaining the region where light is irradiated on the liquid crystal element and the position where sealing material is provided. When the liquid crystal element 100 of the first embodiment is incorporated into a lighting apparatus, which will be described later, the region that includes each of the pixel electrodes 10a-10j in a plane view and does not include each of the thin film transistors 7 (shown by an alternate long and short dash line in the figure) is set as the irradiated region 8, which is the region to be irradiated with light. As a result, the irradiated region 8 includes only the wirings, the lower wirings, and the pixel electrodes, that are transparent (that have translucency). Here, the irradiated region 8 corresponds to a “first region,” and the region excluding the irradiated region 8 and within the region surrounded by the sealing material 6 corresponds to a “second region”.

In a conventional liquid crystal element, thin film transistors are provided adjacent to each pixel electrode in one-to-one correspondence, and therefore often requires a light-shielding film to prevent light from entering each thin film transistor, or a metal film to form a gate electrode or the like for each thin film transistor. In contrast, the liquid crystal element 100 of the present embodiment does not require such a light-shielding film to be provided in the irradiated region 8. For this reason, even in a situation where strong light is incident on the liquid crystal element 100, such as when the liquid crystal element 100 is incorporated in a vehicle lamp which is a type of a lighting apparatus, it is possible to prevent operational malfunctions caused by the liquid crystal layer 5 within the irradiated region 8 becoming hot and exceeding the phase transition temperature. This is because there is no light-shielding film or metal film that generates heat when irradiated with light in the irradiated region 8. Further, by disposing each thin film transistor 7 outside the irradiated region 8, it is possible to prevent each thin film transistor 7 from deteriorating due to irradiation with strong light.

Further, in the liquid crystal element 100 of the first embodiment, each of the lower wirings 13a, etc. are disposed so that they almost entirely overlap with the pixel electrodes 10a in a plane view, at least within the irradiated region 8. This makes it possible to almost completely eliminate malfunctions caused by the voltage of each of the lower wirings 13a, etc. being applied to the liquid crystal layer 5.

Further, the sealing material 6 is provided so as to include each of the pixel electrodes 10a-10j in a plane view and also each thin film transistor 7. In other words, the sealing material 6 is provided so as to include the irradiated region 8 (the first region) and the region adjacent thereto (the second region). As a result, each thin film transistor 7 is covered by the liquid crystal layer 5, thereby the liquid crystal layer 5 functions as a protective layer to suppress deterioration of each thin film transistor 7. In particular, when each of the semiconductor layers 12a, etc. is formed using an organic semiconductor, deterioration of each of the semiconductor layers 12a, etc. may occur due to exposure to air, but such deterioration is suppressed by the protective effect of the liquid crystal layer 5. Here, the thin film transistor 7 does not necessarily have to be formed using an organic semiconductor. In such a case, each thin film transistor 7 may be disposed outside the sealing material 6, and each thin film transistor may be configured not to be covered by the liquid crystal layer 7.

### Second Embodiment

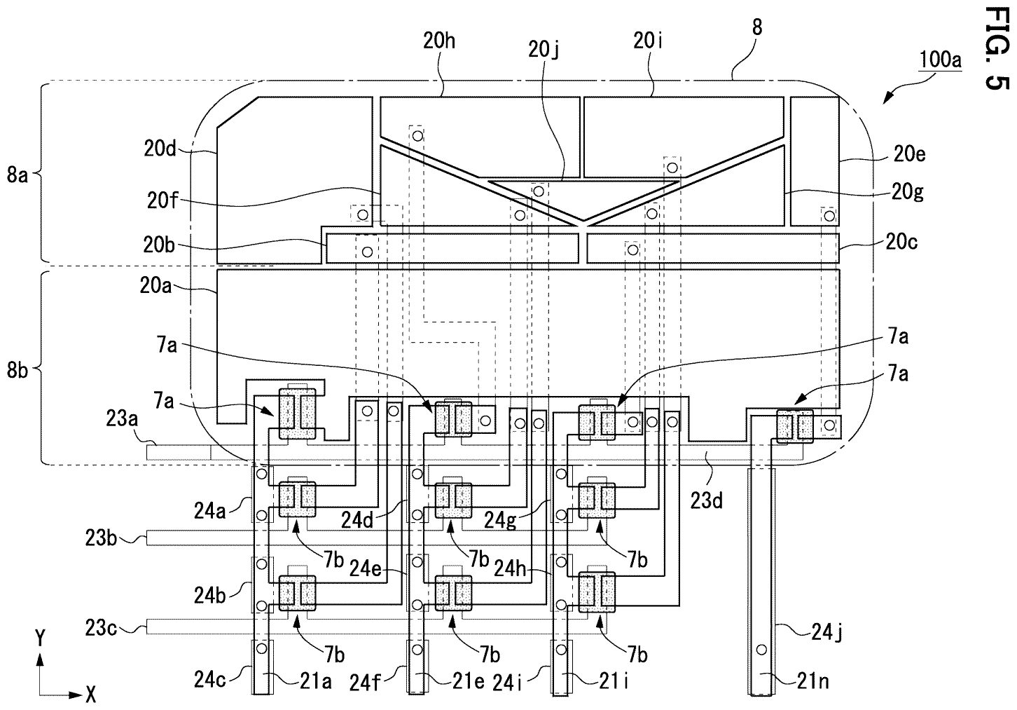

FIG. 5 is a plane view showing the configuration of electrodes and wiring of a liquid crystal element according to a second embodiment. Here, note that the basic configuration of the liquid crystal element 100a of the second embodiment is the same as that of the liquid crystal element 100 of the first embodiment described above, so the following mainly describes the different configuration. Here, note that although the inter-pixel electrodes are omitted here, the liquid crystal element 100a of the second embodiment may also have inter-pixel electrodes in the same manner as the liquid crystal element 100 of the first embodiment.

As shown in FIG. 5, the liquid crystal element 100a of the second embodiment includes pixel electrodes 20a to 20j. The configuration and function of these pixel electrodes 20a to 20j are equivalent to those of the pixel electrodes 10a to 10j in the liquid crystal element 100 of the first embodiment. Each of the pixel electrodes 20a, 20c, 20e, and 20h is associated with one thin film transistor 7a, respectively. Similar to the liquid crystal element 100 of the first embodiment, each thin film transistor 7a is electrically connected to each of the pixel electrodes 20a, 20c, 20e, and 20h using wirings and the lower wirings. Similarly, each of the pixel electrodes 20b, 20d, 20f, 20g, 20i, and 20j is associated with one thin film transistor 7b, respectively. Similar to the liquid crystal element 100 of the first embodiment, each thin film transistor 7b is electrically connected to each of the pixel electrodes 20b, 20d, 20f, 20g, 20i, and 20j using wirings and the lower wirings.

In the liquid crystal element 100a of the second embodiment, three notch parts are provided on the lower side of the pixel electrode 20a in a plane view, and one or two thin film transistors 7a are disposed in each notch part. And, the irradiated region 8 is set to include each of the pixel electrodes 20a-20j and the thin film transistors 7a, but not the thin film transistors 7b. For this reason, thin film transistors using organic semiconductors that are less affected by light irradiation are used for the thin film transistors 7a included in the irradiated region 8. On the other hand, thin film transistors 7b not included in the irradiated region 8 are not affected by light irradiation, so they may use either organic or inorganic semiconductors.

Here, the irradiated region 8 includes a high illuminance region 8a irradiated with light of relatively high illuminance (light for image formation) and a low illuminance region 8b irradiated with light of relatively low illuminance. As shown in FIG. 5, the high illuminance region 8a in the liquid crystal element 100a of the second embodiment is a region including pixel electrodes 20b-20i, and the low illuminance region 8b is a region including pixel electrode 20a. Further, thin film transistors 7a using an organic semiconductor are formed in the low illuminance region 8b. The thin film transistors 7a connected to the pixel electrodes 20c, 20e, and 20h disposed in the high illuminance region 8a are formed in the low illuminance region 8b. For example, if the liquid crystal element 100a is incorporated in a vehicle lamp as a type of lighting apparatus (refer to the fourth embodiment), the high illuminance region 8a can be used to form a high beam, which requires a relatively high illuminance, and the low illuminance region 8b can be used to form a low beam, which requires a relatively low illuminance. Further, the thin film transistors 7a included in the irradiated region 8 can be thin film transistors using an organic semiconductor, and the thin film transistors 7b located outside the irradiated region 8 can be transistors using an inorganic semiconductor.

Further, in the liquid crystal element 100a of the second embodiment, wiring 23d having a portion that functions as a gate electrode of each thin film transistor 7a is included in the irradiated region 8 and is therefore formed using a transparent conductive film such as ITO. On the other hand, wiring 23a which is not included in the irradiated region 8 and is connected to wiring 23d, and wirings 23b and 23c that are not included in the irradiated region 8 are formed using a metal film. As a result, this makes it possible to prevent the wiring included in the irradiated region 8 from being heated by light irradiation, and to achieve low resistance for the wirings not included in the irradiated region 8 by using a metal film.

Further, in the liquid crystal element 100a of the second embodiment, for each of wirings 21a, 21e, 21i, 21n having a portion that functions as the source/drain electrode of each of the thin film transistors 7a, 7b, the lower wirings 24a-24j made of a metal film are provided on the lower layer side of each of wirings 21a, etc., via the insulating film 3. These lower wirings 24a, etc. can be formed simultaneously when wirings 23a-23c are formed.

The lower wiring 24a is provided between wiring 23d and wiring 23b at a position where it overlaps with wiring 21a in a plane view, and is physically and electrically connected to wiring 21a via two contact holes provided in the insulating film 3. Similarly, the lower wiring 24b is provided between wiring 23b and wiring 23c at a position where it overlaps with wiring 21a in a plane view, and is physically and electrically connected to wiring 21a via two contact holes provided in the insulating film 3. Similarly, the lower wiring 24c is provided below wiring 23c in the figure at a position where it overlaps with wiring 21a in a plane view, and is physically and electrically connected to wiring 21a via one contact hole provided in the insulating film 3. These lower wirings 24a to 24c reduce the resistance of wiring 21a.

The lower wirings 24d, 24e, and 24f are each provided on the lower layer side of wiring 21e. The lower wirings 24g, 24h, and 24i are each provided on the lower layer side of wiring 21i. The lower wiring 24j is provided on the lower layer side of wiring 21n. The specific arrangement of these lower wirings 24d etc. is similar to that of the lower layers 24a-24c, so the description will be omitted.

Here, although not shown in the figure, sealing material 6 may be provided in an area that includes all of each of the pixel electrodes 20a, etc. and the thin film transistors 7a, 7b. Further, if each of the thin film transistors 7b is made using an inorganic semiconductor, these thin film transistors 7b may be disposed outside the sealing material 6.

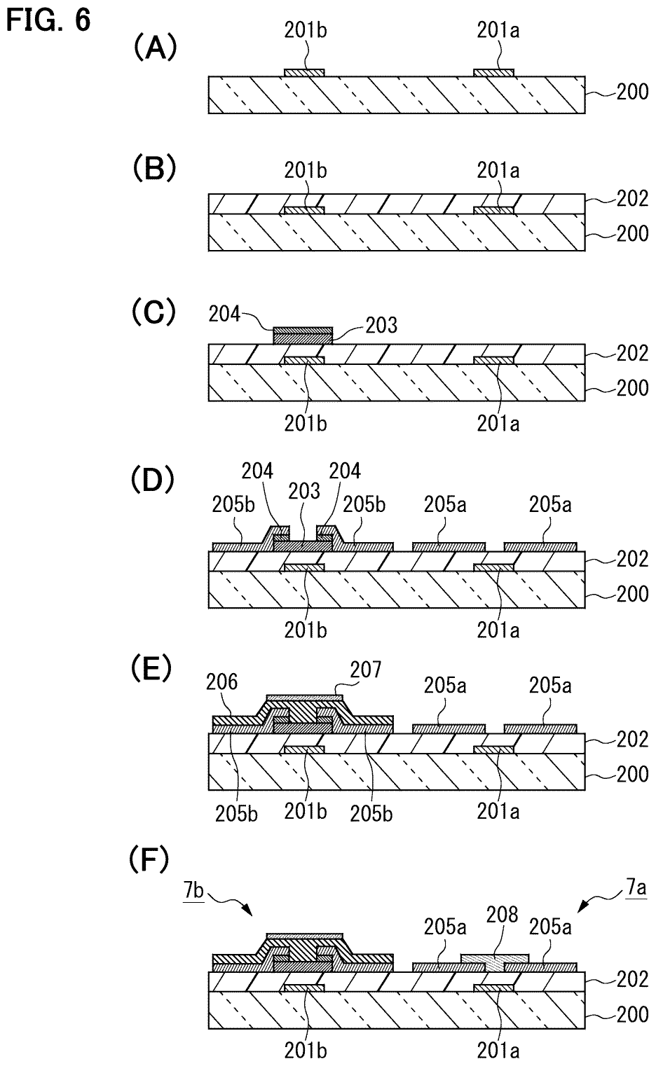

FIG. 6(A) to FIG. 6(F) are diagrams for explaining a manufacturing method for forming a mixture of a thin film transistor using an inorganic semiconductor and a thin film transistor using an organic semiconductor. Here, as an example, a method is explained for forming an inverted coplanar type thin film transistor as a thin film transistor 7b using an inorganic semiconductor, and an inverted staggered type thin film transistor as a thin film transistor 7a using an organic semiconductor.

Wiring having portions that functions as gate electrodes 201a, 201b is formed on one surface side of substrate 200 (FIG. 6(A)). Specifically, for example, a metal film made of material such as Ta, Mo, Cr, Al, Cu, or a conductive film such as ITO is formed and patterned. Film formation methods that can be used include publicly known sputtering method and plasma CVD method or the like. With regard to patterning, for example, a publicly known dry etching method or wet etching method can be used.

Next, an insulating film 202 is formed on one surface side of the substrate 200 so as to cover the wiring having portions that function as gate electrodes 201a and 201b (FIG. 6(B)). For example, an inorganic insulating film such as a SiOx film or a SiNx film is formed by sputtering method or plasma CVD method.

Next, a semiconductor layer 203 and a carrier injection layer 204 are formed on the upper surface of the insulating film 202 (FIG. 6(C)). As the semiconductor layer 203, for example, an amorphous Si film is formed. As shown in the figure, the semiconductor layer 203 and the carrier injection layer 204 are formed in a position that overlaps with the gate electrode 201b, in a plane view.

Next, wiring is formed having portions that will become source/drain electrodes 205b corresponding to the positions of the semiconductor layer 203 and the carrier injection layer 204 (FIG. 6(D)). The carrier injection layer 204 is partially removed to expose the semiconductor layer 203, thereby forming the source/drain electrodes 205b. Specifically, for example, a metal film such as Cu, Al, Mo, or a conductive film such as ITO is formed and patterned. Film formation methods that can be used include publicly known sputtering method and plasma CVD method or the like. With regard to patterning, for example, a publicly known dry etching method or wet etching method can be used.

Next, wiring is formed having portions that will become source/drain electrodes 205a in correspondence with the position of a gate electrode 201a (FIG. 6(D)). Here, a transparent conductive film such as ITO is used to form the wiring having the source/drain electrodes 205a. With regard to film formation and patterning, the above-described publicly known methods can be used. Here, the source/drain electrodes 205b may also be formed using ITO, in which case the source/drain electrodes 205a and the source/drain electrodes 205b can be formed simultaneously in this process.

Next, a passivation film 206 is formed so as to cover the semiconductor layer 203 and each of the source/drain electrodes 205b (FIG. 6(E)). For example, an inorganic insulating film such as a SiOx film or a SiNx film is formed as the passivation film 206 by a publicly known method such as a mask sputtering method. Further, a light-shielding film 207 made of a Cr film or carbon black or the like may be provided on the upper side of this passivation film 206 at a position overlapping with the semiconductor layer 203 in a plane view.

Next, an organic semiconductor layer 208 is formed in a position that overlaps with the gate electrode 201a in a plane view so as to be in contact with each of the source/drain electrodes 205a (FIG. 6(E)). For example, material that will become the semiconductor layer 208 is applied using a droplet discharge method such as inkjet method. Here, note that prior to this process, an alignment film may be patterned on one surface of the substrate 200.

By going through each of the above processes, a thin film transistor 7a using an organic semiconductor and a thin film transistor 7b using an inorganic semiconductor can be formed on one substrate 200.

### Third Embodiment

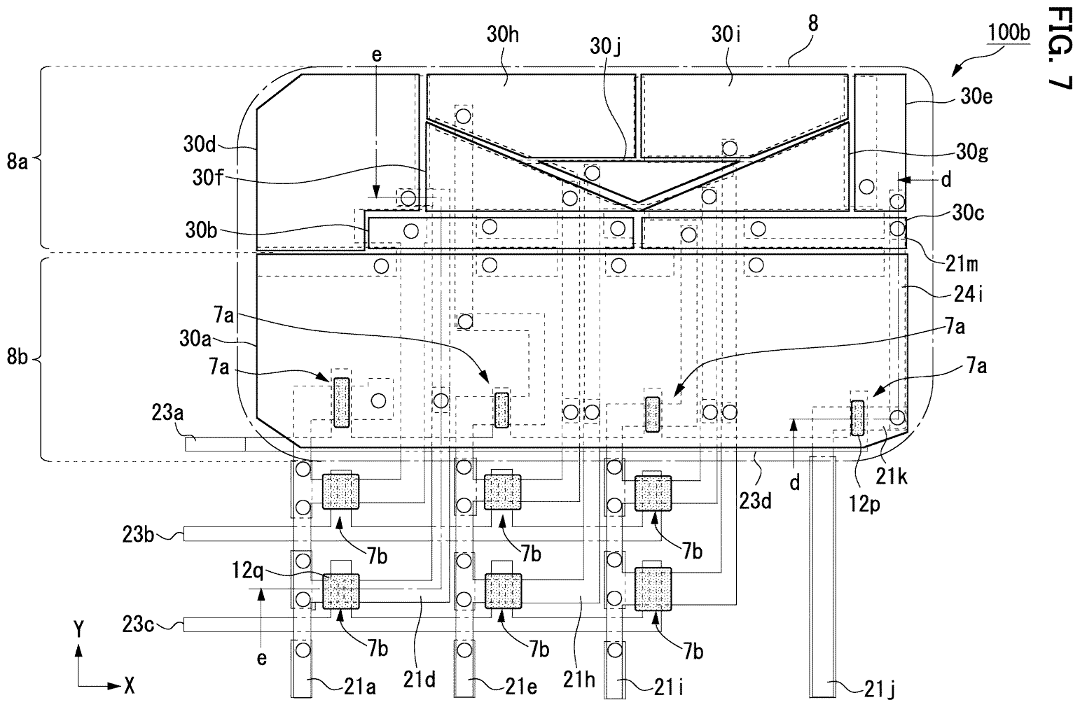

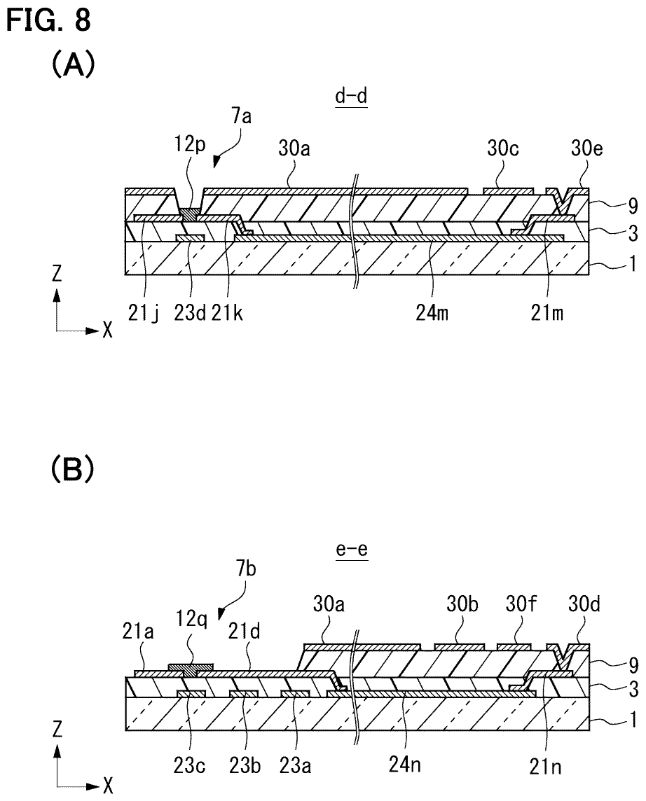

FIG. 7 is a plane view showing the configuration of electrodes and wiring of a liquid crystal element according to a third embodiment. FIG. 8(A) and FIG. 8(B) are partial cross-sectional views showing the configuration of the first substrate of the liquid crystal element of the third embodiment. Here, note that FIG. 8(A) corresponds to the cross section taken along line d-d in FIG. 7, and FIG. 8(B) corresponds to the cross section taken along line e-e in FIG. 7. The basic configuration of the liquid crystal element 100b of the third embodiment is the same as that of the liquid crystal element 100 of the first embodiment and the liquid crystal element 100a of the second embodiment described above, and the main difference is that, as shown in FIG. 8(A) etc., each pixel electrode 30a etc. is provided above the wirings and the lower wirings via an insulating layer 9. Hereinafter, detailed descriptions of common components will be omitted. Here, note that the layer in which each pixel electrode 30a etc. is provided corresponds to a “third layer”.

As shown in FIG. 7, the liquid crystal element 100b of the third embodiment has pixel electrodes 30a to 30j. The configuration and function of these pixel electrodes 30a to 30j are similar to those of the pixel electrodes 10a to 10j in the liquid crystal element 100 of the first embodiment. Further, as in the second embodiment, in the irradiated region 8 in the liquid crystal element 100b of the third embodiment, an illuminance region 8a is set in the region including the pixel electrodes 30b to 30i, and a low illuminance region 8b is set in the region including the pixel electrode 30a.

Each of the pixel electrodes 30a, 30c, 30e, and 30h is associated with one thin film transistor 7a, respectively. As with the liquid crystal element 100 of the first embodiment, each thin film transistor 7a is electrically connected to each of the pixel electrodes 30a, 30c, 30e, and 30h using wirings and lower wirings. Similarly, each of the pixel electrodes 30b, 30d, 30f, 30g, 30i, and 30j is associated with one thin film transistor 7b, respectively. As with the liquid crystal element 100 of the first embodiment, each thin film transistor 7b is electrically connected to each of the pixel electrodes 30b, 30d, 30f, 30g, 30i, and 30j, respectively, using wirings and lower wirings. Further, in the present embodiment, each thin film transistor 7a is provided at a position overlapping with the pixel electrode 30a. For this reason, each thin film transistor 7a is configured using an organic semiconductor. On the other hand, each thin film transistor 7b which is located in a position that does not overlap with a pixel electrode may be configured using either an organic semiconductor or an inorganic semiconductor.

As shown in FIG. 8(A), each pixel electrode 30a, 30c, 30e is provided on the upper layer side of the insulating layer 9 that is provided to cover the insulating layer 3. The same is true for the other pixel electrodes 30b, etc. (not shown). A semiconductor layer 12p is provided in a portion where a part of the pixel electrode 30a is opened. By including this semiconductor layer 12p, a part that functions as a gate electrode of wiring 23d provided on one surface side of the first substrate 1, and wirings 21j and 21k on the upper layer of the insulating layer 3, one thin film transistor 7a is formed. This thin film transistor 7a is connected to the pixel electrode 30e via the lower wiring 24m on one surface of the first substrate 1 and wiring 21m on one surface of the insulating layer 3. The lower wiring 24m and wiring 21m are connected via a contact hole provided in the insulating layer 3. The pixel electrode 30e and wiring 21m are connected via a contact hole provided in the insulating layer 9. Further, a part of wiring 21m is disposed so as to overlap the gap between the pixel electrodes 30c and 30e, and functions as an inter-pixel electrode.

Here, with regard to pixel electrode 30d as well, similar to the above, the electrode is connected to the thin film transistor 7b via wirings 21d, 21n and the lower wiring 24n (refer to FIG. 8(B)). Similarly, a part of wiring 21n is disposed to overlap the gap between pixel electrodes 30d and 30f and functions as an inter-pixel electrode. Further, although a detailed description will be omitted, pixel electrodes 30f, 30g, 30h, 30i, and 30j are also connected to either the thin film transistor 7a or 7b in a similar configuration. On the other hand, pixel electrodes 30a, 30b, and 30c are connected to either the thin film transistor 7a or 7b via each of the wirings provided in the upper layer of insulating layer 3, not through the lower wirings.

As shown in FIG. 8(B), each of the pixel electrodes 30a, 30b, 30d, and 30f is provided on the upper layer side of the insulating layer 9 that is provided to cover the insulating layer 3. The same is true for the other pixel electrodes not shown. A semiconductor layer 12q is provided so as to contact wiring 21a and wiring 21d. By including this semiconductor layer 12q, a portion of the lower wiring 23c provided on one surface side of the first substrate 1 that functions as a gate electrode, and wirings 21a and 21d on the upper layer of the insulating layer 3, one thin film transistor 7b is formed. The lower wirings 23a and 23b are disposed to partially overlap wiring 21d in a plane view and to cross this wiring 21d. Further, the arrangement relationship between these lower wirings 23a and 23b and each of wirings 21h and 21i is also the same. Further, no insulating layer 9 is provided in the portion forming the thin film transistor 7b.

In this way, by disposing a part of pixel electrodes and thin film transistors so as to overlap in a plane view, the size of the entire liquid crystal element 100b can be made more compact while ensuring the area of the pixel electrodes. Further, for example, an auxiliary electrode electrically connected to either the pixel electrodes 30a or 30c may be formed on the insulating film 3 on the lower wiring 24m, which is the routing line for the gate electrode, so as to overlap the gap between the pixel electrodes 30a and 30c disposed between the pixel electrode 30e and the connected thin film transistor 7a. Further, for example, an auxiliary electrode electrically connected to either the pixel electrodes 30a or 30b may be formed on the insulating film 3 on the lower wiring 24n, which is the routing line for the drain electrode, so as to overlap the gap between the pixel electrodes 30a and 30b and the gap between the pixel electrodes 30b and 30f, each disposed between the pixel electrode 30d and the connected thin film transistor 7b. The lower wiring 24m is a drain electrode connected to the pixel electrode 30e, and in the gap between the pixel electrodes 30a and 30c, since the voltage applied to the lower wiring 24m is applied to the liquid crystal layer via the insulating film 3 and the insulating film 9, this can be observed as a malfunction between the electrodes. Similarly, the lower wiring 24n is a drain electrode connected to the pixel electrode 30d, and in the gap between the pixel electrodes 30a and 30c, since the voltage applied to the lower wiring 24n is applied to the liquid crystal layer via the insulating film 3 and the insulating film 9, this can be observed as a malfunction between the electrodes. In order to prevent this malfunction, it is desirable to form the above-described auxiliary electrode in the gap between the pixel electrodes. Here, a case where a drain electrode as a lower wiring being routed in a gap between pixel electrodes has been described, but in this disclosure, a lower wiring being routed in a gap between pixel electrodes may also be a gate electrode or a source electrode. In such a case as well, malfunction can be prevented by forming an auxiliary electrode in the gap between the pixel electrodes.

### Fourth Embodiment

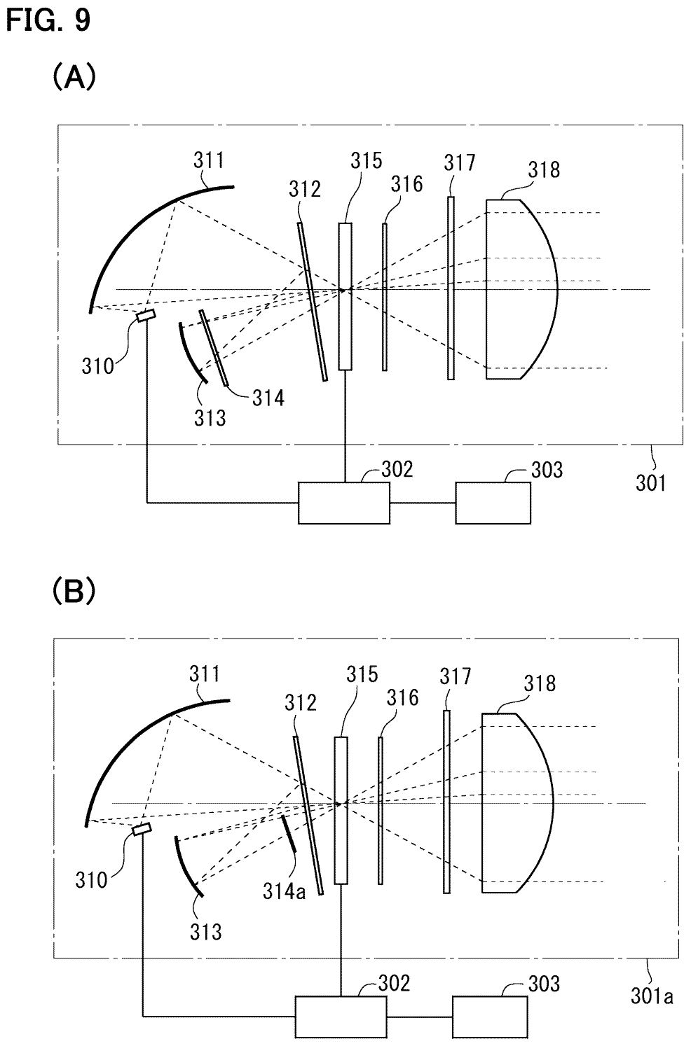

FIG. 9(A) is a diagram showing the configuration of a vehicle lamp system according to one embodiment which is configured using the liquid crystal element according to the above-described embodiments. The vehicle lamp system shown in FIG. 9(A) is configured to include a vehicle lamp (a lighting apparatus) 301, a controller 302, and a camera 303. This vehicle lamp system detects the positions of vehicles in front, faces of pedestrians, or the like present around the vehicle based on an image of the vehicle's surroundings captured by the camera 303, sets a certain range including the position of the vehicle in front as a dimming range (or non-illumination range), sets the other range as a light illumination range to perform selective light irradiation, and further illuminates various shapes of light onto the road surface.

The vehicle lamp 301 is disposed, for example, at a predetermined position at the front part of the vehicle, and and forms an irradiating light to illuminate the front of the vehicle. Here, note that although there is one vehicle lamp 301 provided on each of the left and right sides of the vehicle, only one is illustrated here.

The controller 302 controls the operation of a light source 310 and a liquid crystal element 315 of the vehicle lamp 301. This controller 302 is realized by using a computer system having, for example, a CPU (Central Processing Unit), a ROM (Read Only Memory), a RAM (Random Access Memory), etc., and executing a predetermined operation program in this computer system. The controller 302 of the present embodiment turns on the light source 310 according to operation state of a light switch (not shown) installed near the driver's seat, then sets a light distribution pattern according to target objects detected by the camera 303, such as a forward vehicle (oncoming vehicle, preceding vehicle), pedestrians, road signs, and white lines on the road, and supplies a control signal to the liquid crystal element 315 to form an image corresponding to this light distribution pattern.

The camera 303 captures an image of the space in front of the vehicle to generate an image, and performs a predetermined image recognition process on this image to detect the position, range, size, type, etc. of the target objects such as the vehicle in front as described above. The detection result from the image recognition process is supplied to the controller 302 connected to the camera 303. The camera 303 is installed at a predetermined position inside the vehicle (for example, above the windshield) or at a predetermined position outside the vehicle (for example, inside the front bumper). If the vehicle is equipped with a camera for another purpose (for example, an automatic braking system, etc.), the camera may be shared.

Here, the image recognition processing function in the camera 303 may be replaced by the controller 302. In this case, the camera 303 outputs the generated image to the controller 302, and image recognition processing is performed by the controller 302 side based on this image. Alternatively, both the image and the result of the image recognition processing based on the image may be supplied from the camera 303 to the controller 302. In this case, the controller 302 may further perform its own image recognition processing using the image obtained from the camera 303.

The vehicle lamp 301 shown in FIG. 9A is configured to include the light source 310, reflectors (reflective members) 311, 313, a polarizing beam splitter (first polarizing element) 312, a ¼ wavelength plate 314, the liquid crystal element 315, an optical compensator 316, a polarizer (second polarizing element) 317, and a projection lens 318. These elements are integrated together in a single housing, for example. Further, the light source 310 and the liquid crystal element 315 are each connected to the controller 302.

The light source 310 includes a drive circuit and emits light under the control of the controller 302. This light source 310, like the light source for verification purpose as described above, is a white LED equipped with a blue LED and a yellow phosphor disposed at a position where the light emitted by the blue LED is incident, and the blue LED excites the yellow phosphor, and white light is obtained by mixing the blue and yellow colors.

The reflector 311 is disposed in correspondence with the light source 310, and reflects and condenses the light emitted from the light source 310 so that it is focused at the position of the liquid crystal element 315 (for example, approximately at the center in the thickness direction of the liquid crystal element 315), and guides the light toward the polarizing beam splitter 12 and into the liquid crystal element 315. The reflector 311 is a reflecting mirror having an ellipsoidal reflective surface, for example. In this case, the light source 310 can be disposed near the focal point of the reflective surface of the reflector 311. Here, in place of the reflector 311, a lens may be used as a light condensing part.

The polarizing beam splitter 12 is a transmissive-reflective type polarizing element that transmits polarized light in a specific direction of the incident light and reflects polarized light in a direction perpendicular to this, and is disposed on the light incident surface side of the liquid crystal element 315 at an angle to this light incident surface. As such a polarizing beam splitter 12, for example, a wire grid type polarizing element or a multilayer film polarizing element can be used.

The reflector 313 is provided at a position where the light reflected by the polarizing beam splitter 12 can be incident, and reflects and focuses the incident light so that it is focused at the position of the liquid crystal element 315, and causes the light to be incident on the polarizing beam splitter 12.

The ¼ wavelength plate 314 is disposed on the optical path between the polarizing beam splitter 12 and the reflector 313, and imparts a phase difference to the incident light. In the present embodiment, the light which is reflected by the polarizing beam splitter 12, passes through the ¼ wavelength plate 314, is reflected by the reflector 313, and passes through the ¼ wavelength plate 314 again, thereby rotating the polarization direction by 90°, and re-enters the polarizing beam splitter 312. As a result, the re-entering light is in a state where it is more easily transmitted through the polarizing beam splitter 312, thereby improving the efficiency of light utilization.

Here, as in a modified embodiment of the vehicle lamp 301a shown in FIG. 9(B), a ½ wavelength plate 314a can be used instead of the ¼ wavelength plate 314. In this case, the ½ wavelength plate 314a is positioned so that the light reflected by the polarizing beam splitter 12 does not enter, but the light reflected by the reflector 313 enters.

The liquid crystal element 315 is disposed at a position including the focal points of the light reflected and focused by each of the reflectors 311 and 313, and is disposed so that the light is incident thereon. The liquid crystal element 315 has a plurality of pixel parts (light modulation parts) that can be controlled independently of each other. In the present embodiment, the liquid crystal element 315 has a driver (not shown) for applying a drive voltage to each pixel part. The driver applies a drive voltage to the liquid crystal element 315 for individually driving each pixel part based on a control signal supplied from the controller 302. As shown in the figure, the light incident on the liquid crystal element 315 is incident at a wide angle with respect to the light incident surface of the liquid crystal element 315. Specifically, the light is incident at a wide angle of about 40° to 60° with respect to the normal direction of the light incident surface.

The optical compensator 316 compensates for the phase difference of the light transmitted through the liquid crystal element 315 and increases the degree of polarization, and is disposed on the light emitting surface side of the liquid crystal element 315. Specifically, the phase difference of the optical compensator 316 is set so that its phase difference combined with the phase difference of the liquid crystal layer 315 is 0 or a value close to 0. Here, the optical compensator 316 may be omitted.

The polarizer 317 is disposed on the light emitting surface side of the liquid crystal element 315. An image corresponding to the light distribution pattern of the light irradiated forward of the vehicle is formed by the polarizing beam splitter 12, the polarizer 317, and the liquid crystal element 315 disposed therebetween. The transmission axis of the polarizer 317 is disposed so as to be approximately perpendicular to the transmission axis of the polarizing beam splitter 312. Further, each of the transmission axes of the polarizer 317 and the polarizing beam splitter 312 is disposed so as to form an angle of approximately 45° in a plane view with respect to the alignment direction when no voltage is applied, at approximately the center of the layer thickness direction of the liquid crystal layer of the liquid crystal element 315.

The projection lens 318 is disposed at a position where light reflected and focused by the reflectors 311, 313 and transmitted through the liquid crystal element 315 can be incident, and projects this incident light forward of the vehicle. The projection lens 318 is disposed so that its focal point is formed on the liquid crystal layer of liquid crystal element 315. The optical axis of the projection lens 318 runs along the left-right direction in the figure, as shown by an alternate long and short dash line in the figure.

### Modified Example

Here, note that the present disclosure is not limited to the contents of the above-described embodiments, and various modifications can be made within the scope of the gist of the present disclosure. For example, in the above-described embodiment, a vehicle lamp is given as an example of a lighting apparatus configured using a liquid crystal element, but the lighting apparatus is not limited thereto. Further, in the above-described embodiments, a thin film transistor is described as an example of a thin film switching element, but a thin film switching element such as a MIM (Metal Insulator Metal) element may be used instead of a thin film transistor. Further, the operating mode (alignment mode) of the liquid crystal layer is not limited to the vertical alignment mode as described above.

The present disclosure has features as appended below.

### Appendix 1

A liquid crystal element including:
a first substrate and a second substrate disposed with one surface facing each other;
a liquid crystal layer disposed between the first substrate and the second substrate;
a plurality of pixel electrodes including those having different shapes in a plane view, which are provided on the first substrate side using a transparent conductive film;
a plurality of thin film switching elements provided on the first substrate side, each corresponding to each of the pixel electrodes;
a plurality of first wirings provided on the first substrate side using a transparent conductive film, which connects each of the pixel electrodes and each of the thin film switching elements; and
a counter electrode provided on the second substrate side, which is disposed to overlap each of the pixel electrodes in a plane view;
where each of the pixel electrodes is entirely disposed within a first region to which light for image formation is irradiated, and
where each of the thin film switching elements is disposed in a second region that is adjacent to the first region in a plane view and to which the light for image formation is not irradiated.

### Appendix 2

A liquid crystal element including:
a first substrate and a second substrate disposed with one surface facing each other;
a liquid crystal layer disposed between the first substrate and the second substrate;
a plurality of pixel electrodes including those having different shapes in a plane view, which are provided on the first substrate side using a transparent conductive film;
a plurality of thin film switching elements provided on the first substrate side, each corresponding to each of the pixel electrodes;
a plurality of first wirings provided on the first substrate side using a transparent conductive film, which connects each of the pixel electrodes and each of the thin film switching elements; and
a counter electrode provided on the second substrate side, which is disposed to overlap each of the pixel electrodes in a plane view;
where each of the thin film switching elements has a plurality of first thin film switching elements and a plurality of second thin film switching elements, and at least each of the first thin film switching elements is made of an organic semiconductor,
where each of the pixel electrodes and each of the first switching elements are entirely disposed in a first region where light for image formation is irradiated, and
where each of the second thin film switching elements is disposed in a second region that is adjacent to the first region in a plane view and is not irradiated with the light for image formation.

### (Appendix 3)

The liquid crystal element according to appendix 2,
where each of the first thin film switching elements is disposed in a notch part provided in at least one of each of the pixel electrodes and is disposed so as not to overlap any of each of the pixel electrodes in a plane view.

### (Appendix 4)

The liquid crystal element according to appendix 2,
where each of the first thin film switching elements is provided at a position overlapping at least one of each of the pixel electrodes in a plane view.

### (Appendix 5)

The liquid crystal element according to any one of appendices 1 to 3 further including:
a plurality of second wirings including a portions that functions as control electrodes for each of the thin film switching elements; and
a plurality of third wirings including a portion that functions as input/output electrodes for each of the thin film switching elements,
where each of the first wirings and each of the second wirings are disposed in a first layer relatively close to one surface of the first substrate on the first substrate side,
where each of the third wirings and each of the pixel electrodes are disposed in a second layer relatively far from the one surface of the first substrate on the first substrate side, and
where an insulating layer is provided between the first layer and the second layer.

### (Appendix 6)

The liquid crystal element according to appendix 2 or 4 further including:
a plurality of second wirings including a portion that functions as a control electrode for each of the thin film switching elements, and
a plurality of third wirings including a portion that functions as an input/output terminal electrode for each of the thin film switching elements,
where each of the first wirings and each of the second wirings are disposed in a first layer relatively closer to one surface of the first substrate on the first substrate side,
where each of the third wirings is disposed in a second layer relatively far from the one surface of the first substrate than the first layer on the first substrate side,
where each of the pixel electrodes is disposed in a third layer that is relatively far from the one surface of the first substrate than the second layer on the first substrate side, and
where an insulating layer is provided between the first layer and the second layer and between the first layer and the second layer.

### (Appendix 7)

The liquid crystal element according to any one of appendices 1 to 6 further including a sealing material provided between the first substrate and the second substrate to surround the liquid crystal layer,
where the sealing material is disposed to include the first region and the second region.

### (Appendix 8)

The liquid crystal element according to any one of appendices 2 to 4 or 6,
where the first region has a high illuminance region in which the light for image formation with a relatively high intensity is irradiated and a low illuminance region in which the light for image formation with a relatively low intensity is irradiated, and
where each of the first switching elements is entirely disposed in the low illuminance region.

### (Appendix 9)

A lighting apparatus including:
the liquid crystal element according to any one of appendices 1 to 8;
a light source;
a light condensing part that collects light emitted from the light source to form the light for image formation and causes the light for image formation to be incident on the liquid crystal element;
a pair of polarizing elements that are disposed opposite each other with the liquid crystal element therebetween; and
a lens that projects the light that has passed through the liquid crystal element.

### (Appendix 10)

A vehicle lamp system including:
a vehicle lamp configured using the lighting apparatus according to appendix 9,
a sensor that detects a target object present around a vehicle; and
a controller that controls operation of the liquid crystal element in accordance with the state of the target object detected by the sensor.

### REFERENCE SIGNS LIST

1: First substrate
2: Second substrate
3: Insulating layer
4: Counter electrode
5: Liquid crystal layer
6: Sealing material
7: Thin film transistor
8: Irradiated region
10a-10j: Pixel electrode
11a-11p: Wiring
12a-12j: Semiconductor layer
13a-13c: Lower wiring
14a-14i: Lower wiring
15a-15h: Inter-pixel electrode
100: Liquid crystal element

1. A liquid crystal element comprising:
a first substrate and a second substrate disposed with one surface facing each other;
a liquid crystal layer disposed between the first substrate and the second substrate;
a plurality of pixel electrodes including those having different shapes in a plane view, which are provided on the first substrate side using a transparent conductive film;
a plurality of thin film switching elements provided on the first substrate side, each corresponding to each of the pixel electrodes;
a plurality of first wirings provided on the first substrate side using a transparent conductive film, which connects each of the pixel electrodes and each of the thin film switching elements; and
a counter electrode provided on the second substrate side, which is disposed to overlap each of the pixel electrodes in a plane view;
wherein each of the pixel electrodes is entirely disposed within a first region to which light for image formation is irradiated, and
wherein each of the thin film switching elements is disposed in a second region that is adjacent to the first region in a plane view and to which the light for image formation is not irradiated.

2. A liquid crystal element comprising:
a first substrate and a second substrate disposed with one surface facing each other;
a liquid crystal layer disposed between the first substrate and the second substrate;
a plurality of pixel electrodes including those having different shapes in a plane view, which are provided on the first substrate side using a transparent conductive film;
a plurality of thin film switching elements provided on the first substrate side, each corresponding to each of the pixel electrodes;
a plurality of first wirings provided on the first substrate side using a transparent conductive film, which connects each of the pixel electrodes and each of the thin film switching elements; and
a counter electrode provided on the second substrate side, which is disposed to overlap each of the pixel electrodes in a plane view;
wherein each of the thin film switching elements has a plurality of first thin film switching elements and a plurality of second thin film switching elements, and at least each of the first thin film switching elements is made of an organic semiconductor,
wherein each of the pixel electrodes and each of the first thin film switching elements are entirely disposed in a first region where light for image formation is irradiated, and
wherein each of the second thin film switching elements is disposed in a second region that is adjacent to the first region in a plane view and is not irradiated with the light for image formation.

3. The liquid crystal element according to claim 2,
wherein each of the first thin film switching elements is disposed in a notch part provided in at least one of each of the pixel electrodes and is disposed so as not to overlap any of each of the pixel electrodes in a plane view.

4. The liquid crystal element according to claim 2,
wherein each of the first thin film switching elements is provided at a position overlapping at least one of each of the pixel electrodes in a plane view.

5. The liquid crystal element according to claim 1 further comprising:
a plurality of second wirings including a portion that functions as control electrodes for each of the thin film switching elements; and
a plurality of third wirings including a portion that functions as input/output electrodes for each of the thin film switching elements,
wherein each of the first wirings and each of the second wirings are disposed in a first layer relatively close to one surface of the first substrate on the first substrate side,
wherein each of the third wirings and each of the pixel electrodes are disposed in a second layer relatively far from the one surface of the first substrate on the first substrate side, and
wherein an insulating layer is provided between the first layer and the second layer.

6. The liquid crystal element according to claim 2 further comprising:
a plurality of second wirings including a portion that functions as a control electrode for each of the thin film switching elements, and
a plurality of third wirings including a portion that functions as an input/output electrode for each of the thin film switching elements,
wherein each of the first wirings and each of the second wirings are disposed in a first layer relatively closer to one surface of the first substrate on the first substrate side,
wherein each of the third wirings is disposed in a second layer relatively far from the one surface of the first substrate than the first layer on the first substrate side,
wherein each of the pixel electrodes is disposed in a third layer that is relatively far from the one surface of the first substrate than the second layer on the first substrate side, and
wherein an insulating layer is provided between the first layer and the second layer and between the second layer and the third layer.

7. The liquid crystal element according to claim 1 further comprising a sealing material provided between the first substrate and the second substrate to surround the liquid crystal layer,
wherein the sealing material is disposed to include the first region and the second region.

8. The liquid crystal element according to claim 2,
wherein the first region has a high illuminance region in which the light for image formation with a relatively high intensity is irradiated and a low illuminance region in which the light for image formation with a relatively low intensity is irradiated, and
wherein each of the first switching elements is entirely disposed in the low illuminance region.

9. A lighting apparatus comprising:
the liquid crystal element according to claim 1;
a light source;
a light condensing part that collects light emitted from the light source to form the light for image formation and causes the light for image formation to be incident on the liquid crystal element;
a pair of polarizing elements that are disposed opposite each other with the liquid crystal element therebetween; and
a lens that projects the light that has passed through the liquid crystal element.

10. A vehicle lamp system comprising:
a vehicle lamp configured using the lighting apparatus according to claim 9,
a sensor that detects a target object present around a vehicle; and
a controller that controls operation of the liquid crystal element in accordance with the state of the target object detected by the sensor.
